(19) United States
(12) Patent Application Publication
(10) Pub. No.: US 2015/0235318 A1
(43) Pub. Date: Aug. 20, 2015

(54) TRADING SYSTEMS AND METHODS

(71) Applicant: William Huan, San Jose, CA (US)

(72) Inventor: William Huan, San Jose, CA (US)

(21) Appl. No.: 14/626,620

(22) Filed: Feb. 19, 2015

Related U.S. Application Data
(60) Provisional application No. 61/941,941, filed on Feb. 19, 2014.

(51) Int. Cl. G06Q 40/04

(52) U.S. Cl. CPC G06Q 40/04

(57) ABSTRACT

Example trading systems and methods are described. In one implementation, a method allows a user to construct algorithmic trading strategies by presenting to the user components of algorithmic trading strategies. These components include declarative rules and expressions associated with algorithmic trading strategies, and the user constructs an algorithmic trading strategy using the declarative rules and expressions. An algorithmic trading strategy is tested by compiling the performance of the algorithmic trading strategy against historical market data. The user also has the option to select a specific time interval over which to evaluate the performance of a constructed algorithmic trading strategy. The testing results are communicated to the user.

### CROSS REFERENCE TO RELATED APPLICATIONS

This patent application claims priority to Provisional Application Ser. No. 61/941,941, entitled “A Visual, Algorithmic, Spread Trading System”, filed Feb. 19, 2014, the disclosure of which is incorporated by reference herein in its entirety.

### TECHNICAL FIELD

The systems and methods described herein relate to systems and methods associated with trading strategies, including graphical user interface methods, client-server systems and database architectures.

### BACKGROUND

In the field of software-based algorithms for trading strategies, there exists a need for methods that provide a user having limited computer programming experience with a way to construct and test trading strategies via a graphical user interface. The processes of constructing and testing trading strategies typically require a user to write a computer program using a programming language such as Java or C++. For a user who is inexperienced with writing computer programs, constructing algorithmic trading strategies is thus a challenging task, if not an impossible one. Furthermore, there is a need of a graphical interface that allows a user to submit constructed trading strategies for testing and evaluation, possibly with respect to past market data, with evaluation results provided to the user in real-time. This allows a user to understand how well a particular strategy performs with respect to market history. Based on the results of the evaluation, the user can return to his or her trading strategy and modify the trading strategy if he or she needs to.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an environment within which an example embodiment may be implemented.

FIG. 2 is a flow diagram depicting an embodiment of a method for constructing and testing a trading strategy.

FIG. 3 is a flow diagram depicting the overall user workflow of the system.

FIG. 4 is a flow diagram depicting an embodiment of a method for generating a trading strategy.

FIG. 5 is a flow diagram depicting an embodiment of a method for developing the visual blocks that represent trading strategies or trading rules.

FIG. 6 is a flow diagram depicting an embodiment of a method for translating the visual trading rules into executable machine object code that can be used to evaluate the trading strategy.

FIG. 7 illustrates an example of a graphical user interface that allows users to create algorithmic trading strategies using visual drag-and-drop trading blocks.

FIG. 8 illustrates an example of a visual representation of the components of the graphical user interface as jigsaw puzzle-shaped trading blocks.

FIG. 9 depicts an example of a visual representation of conditional trading rules as components of the graphical user interface.

FIG. 10 depicts an example of a visual representation of market studies.

FIG. 11 illustrates an example of a visual representation of various types of trade actions.

FIG. 12 illustrates an example of creating a list of stocks to trade based on specific criteria.

FIG. 13 depicts an example of a visual representation of various general programming constructs.

FIG. 14 depicts an example of a complex trading rule by connecting various trading blocks together.

FIG. 15 illustrates how the graphical user interface dynamically updates the risk graph associated with a particular spread as the spread is modified.

FIG. 16 illustrates an example of the construction of a multi-legged option spread.

FIG. 17 depicts an example of how a user may define the rules to create complex option spreads.

FIG. 18 depicts another example of how a user may define the rules to create complex option spreads.

FIG. 19 illustrates an example of a visual representation of how users can create complex option spread strategies.

FIG. 20 represents a flow diagram depicting an embodiment of a method for executing the rules used to construct the user-defined option spreads.

FIG. 21 depicts an alternative method of displaying the results from the testing of an algorithmic trading strategy to a user.

FIG. 22 depicts another alternative method of displaying the results from the testing of an algorithmic trading strategy to a user.

FIG. 23 shows an example computing device capable of implementing the methods and techniques discussed herein.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein describe a method implemented on a computer system that allows a user to construct and test trading strategies via a graphical user interface by using graphical objects associated with the graphical user interface via interactive methods such as drag-and-drop. Trading strategies can be described as financial transactions that are conditioned to occur if certain conditions are met. Trading strategies include, for example, strategies for buying and selling stocks, bonds, options and the like. As discussed above, the construction of trading strategies usually requires a user to write a computer program in a programming language such as Java or C++, users who are not proficient with programming would find it difficult, if not impossible, to construct such trading strategies. The systems and methods described herein allow such users to easily construct trading strategies, since the graphical method approach circumvents the need for programming. In addition, the described systems and methods provide a convenient method for even experienced programmers, since graphical methods are usually simpler than methods that require a user to write a program using computer programming language.

The systems and methods described herein also allow a user to dynamically test a trading strategy in real-time using the graphical method without having to write computer code. Furthermore, the systems and methods described herein allow a user to test the performance of a constructed trading strategy in real-time with respect to market history data, wherein different temporal lengths of data can be selected via the graphical user interface.

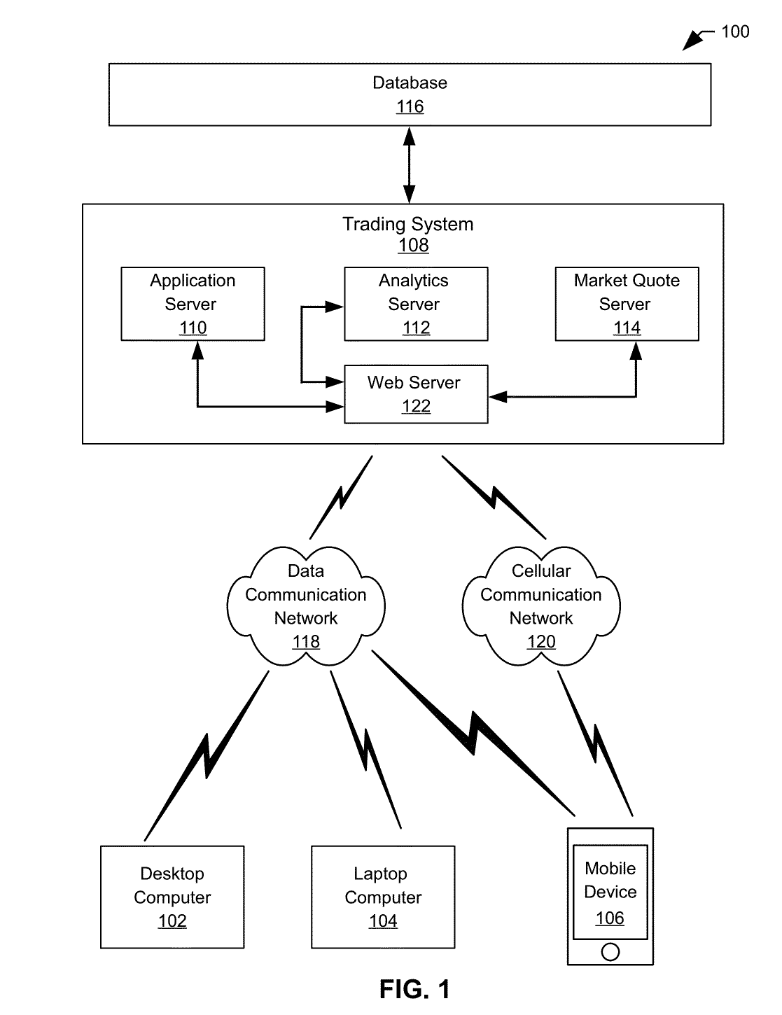

FIG. 1 is a block diagram depicting a particular environment 100 within which an example embodiment may be implemented. The environment 100 includes client devices such as a desktop computer 102, a laptop computer 104, and a mobile device 106. The desktop computer 102 and the laptop computer can communicate with the trading system 108 via a data communication network 118. The mobile device can communicate with the trading system 108 via either the data communication network 118 or a cellular communication network 120. Trading system 108 can include an application server 110, an analytics server 112, a market quote server 114 and a web server 122. The trading system 108 communicates with a database 116. In some embodiments, database 116 is separate from trading system 108, as shown in FIG. 1. In other embodiments, database 116 is incorporated into trading system 108 or into one of the servers within trading system 108.

In a particular embodiment, client devices such as desktop computer 102 or laptop computer 104 can communicate to web server 122 via data communication network 118. Client devices such as mobile device 106 can communicate with the web server 122 via either data communication network 118 or cellular communication network 120. The web server 122 communicates with application server 110 to retrieve user profiles and saved trading data which, in turn, are retrieved by the application server 110 from the database 116 where the user profiles and trading data are stored. Client devices such as desktop computer 102, laptop computer 104 and mobile device 106 receive mobile code from the web server 122. This mobile code allows the client devices such as desktop computer 102, laptop computer 104 and mobile device 106 to display a graphical user interface for the creation and editing of visual trading strategies.

When a client submits a trading strategy to the web server 122 via any of the client devices, the trading strategy is saved in the database 116. When prompted by the user, the trading strategy is retrieved from the database 116 by the analytics server 112 and the historical performance of the trading strategy is evaluated by the analytics server 112. Historical market data may be periodically retrieved from external market servers by the market quote server 114 and stored in the database 116. External market data providers may include but are not limited to Exchanges, TickData, LiveVol, Esignal and Reuters.

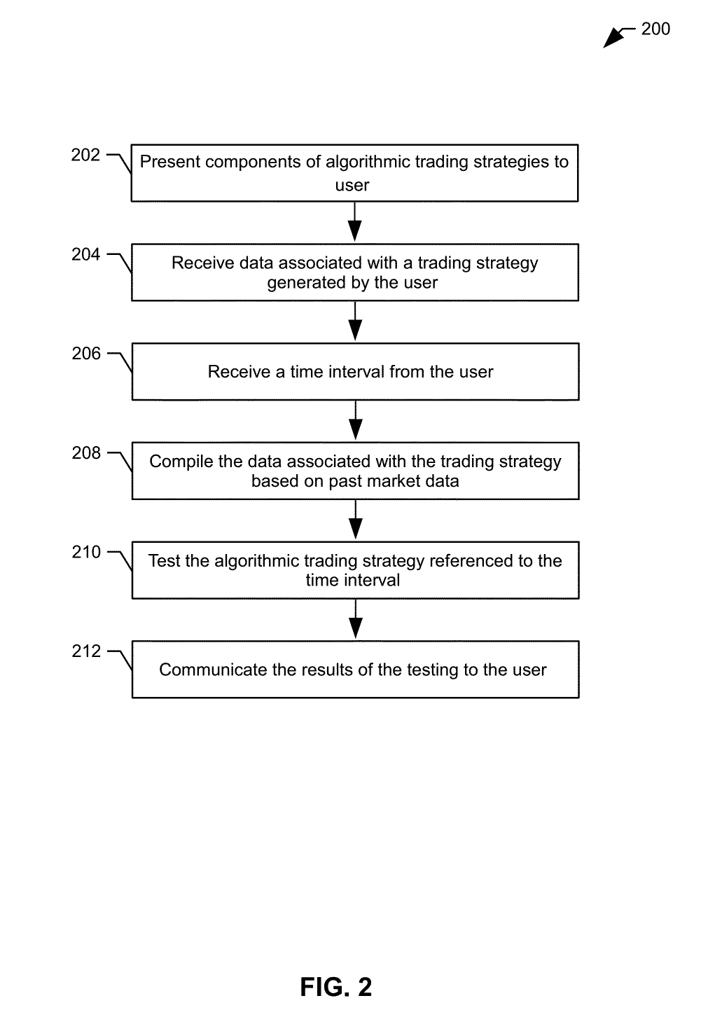

FIG. 2 represents a flow diagram depicting an embodiment of a method 200 for constructing and testing a trading strategy. As shown in FIG. 2, method 200 presents components of algorithmic trading strategies to a user at 202. As used herein, the term “components of algorithmic trading strategies” describes the graphic components associated with the graphical user interface, displayed on client device 102, 104 or 106, with the graphic components being used to construct the trading strategy. One example of a graphic component is described herein as a “trading block.” A trading block is used as a graphic component by the user to construct a part of an algorithmic trading strategy via interactive graphical methods such as drag-and-drop. Next, at 204, the system receives data associated with a trading strategy generated by the user. A time interval is then received from the user at 206. Based on the generated trading strategy and the selected time interval, data associated with the trading strategy based on past market data is compiled at 208. The algorithmic trading strategy is tested referenced to the time interval at 210. Finally, the results of the testing are communicated back to the user at 212.

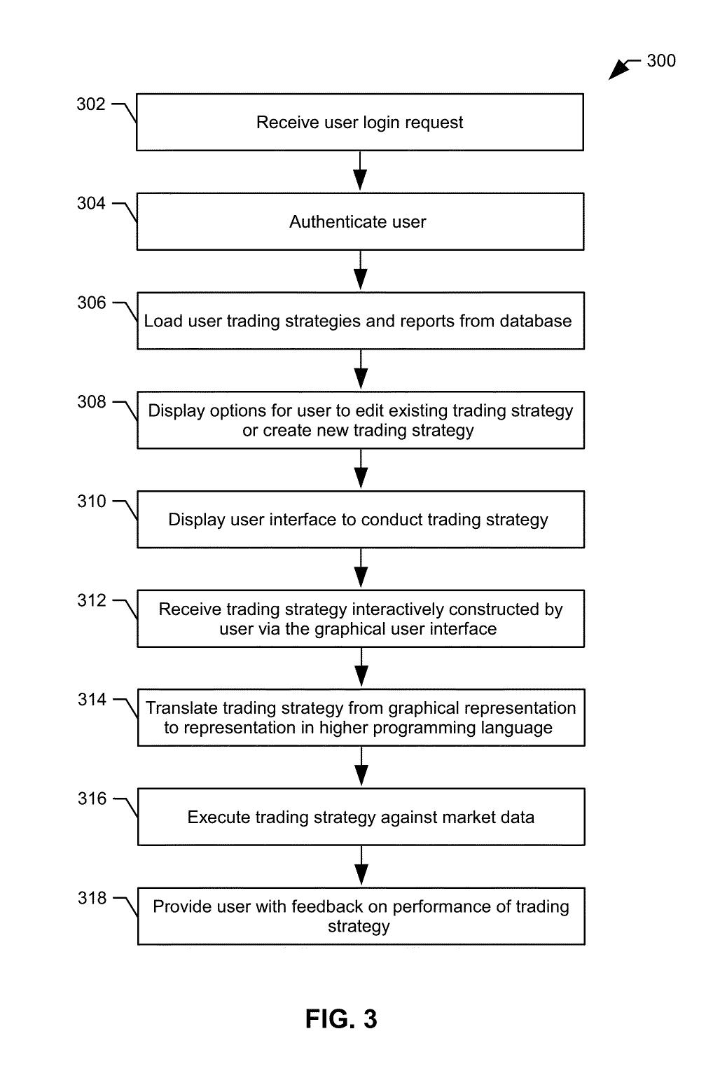

FIG. 3 is a flow diagram depicting a method 300 representing the overall user workflow of the system. As shown in FIG. 3, the method 300 first receives a user login request at 302, wherein a user logs in from a client device that includes computing systems such as desktop computer 102, laptop computer 104 and mobile device 106. After the web server 122 authenticates the user at 304, the system loads user profile data that includes user account information, trading strategies and reports from the database 116 at 306. Next, at 308, the system displays options for the user to edit an existing trading strategy or to create a new trading strategy. A user interface enabling the user to conduct the trading strategy is then displayed to the user at 310. 308 and 310 are achieved by the trading system 108 sending client device 102, 104 or 106 data or code such that a graphical user interface can be displayed on the client device. Subsequently, the trading strategy interactively constructed by the user via the graphical user interface via interactive graphical methods such as drag-and-drop is received at 312. The user is also given the option to save his or her data to the web server 122, which then saves the data in the database 116. Next, at 314, the trading strategy is translated from a graphical representation to a representation in a higher programming language. At 316, the trading strategy is executed against market data by the analytics server 112, wherein the market data includes historical market data. Finally, at 318, once the analysis is complete, the user is provided feedback on the performance of the trading strategy via a performance report.

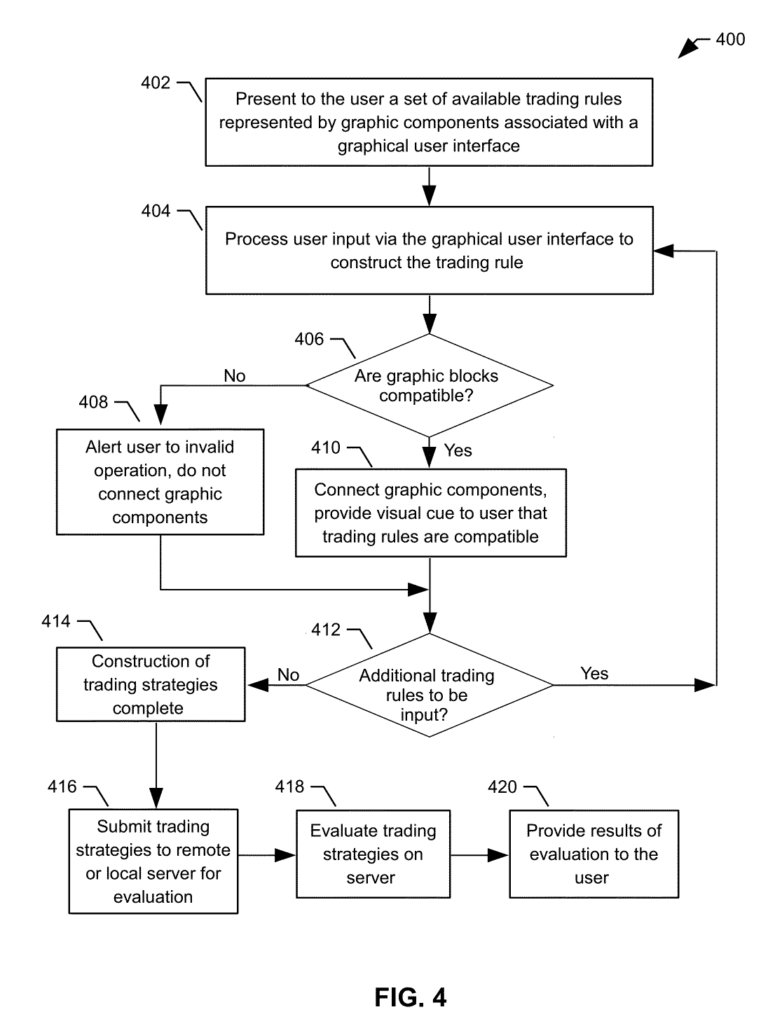

FIG. 4 is a flow diagram 400 depicting an embodiment of a method for generating a trading strategy. Initially, at 402, a set of available trading rules represented by graphic components associated with a graphical user interface is presented to a user by method 400. The user input via the graphical user interface to construct a trading strategy, wherein the user input can be done by interactive methods such as drag-and-drop, is processed at 404. A check for whether the graphic components being connected by the user are compatible is performed at 406. If the graphic components are compatible, the method proceeds to 410, wherein the graphic components are connected and the user is provided with a visual cue such as highlighting the compatible graphic components. If the graphic blocks are not compatible as determined by 406, the method proceeds to 408, wherein the user is alerted to an invalid operation being attempted and the graphic components are not connected together. Additional cues to the user regarding the lack of graphic component connectivity with regards to incompatible graphic components can be included by features such as a simulated graphical repelling operation, wherein incompatible graphic components can be made to graphically repel each other in the event that the corresponding invalid connection is attempted by the user. After validating and processing the connectivity of the graphic components, the method determines whether there any additional trading rules to be input at 412. If there are any additional trading rules to be input, the method goes back to 402, wherein the user is presented with a set of available trading rules represented by graphic components associated with a graphical user interface. If there are no additional trading rules to be input, the method proceeds 414, which declares the construction of trading strategies to be complete. Next, at 416, the trading strategies are submitted to a remote or local server for evaluation. 418 entails the evaluation of the trading strategies on the server and finally, at 420, the results of the evaluation are provided to the user.

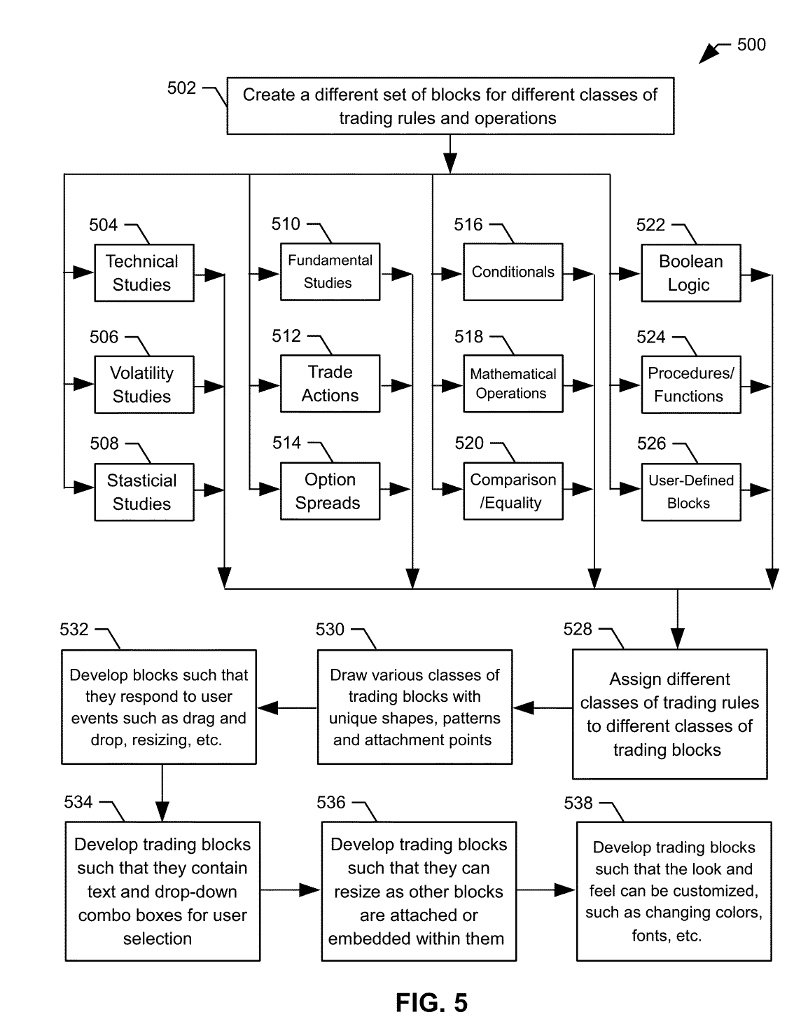

FIG. 5 is a flow diagram depicting an embodiment of a method 500 for developing the visual blocks that represent trading strategies or trading rules. Initially, at 502, the method 500 creates different sets of trading blocks for different classes of trading rules and operations. One set of trading blocks can be described as market studies, and can include technical studies 504, volatility studies 506, statistical studies 508 and fundamental studies 510. Another set of trading blocks can include trade actions 512, which includes operations such as buying, selling, rolling and closing. Another set of trading blocks can include option spreads 514 which includes, for example, iron condor, collars and double diagonals. Other sets of trading blocks include conditionals 516, mathematical operations 518, comparison/equality 520, Boolean logic 522, procedures/functions 524, and user-defined trading blocks 526.

Method 500 continues to assign different classes of trading rules to different classes of trading blocks at 528. Trading rules which can be combined together are assigned to trading blocks that can be connected together. For instance, option spreads can be combined together and selling a put vertical can be combined with selling a call vertical to create an iron condor spread. Hence, trading blocks representing option spreads 514 may be able to connect to other trading blocks that represent option spreads 514.

Next, at 530, the method 500 draws various classes of trading blocks with unique shapes, patterns and attachment points. In some embodiments, the trading blocks are drawn (i.e., graphically represented) in a programming language that runs in a web browser, wherein the kinds of programming language that can be used to draw the trading blocks include, but are not limited to, JavaScript, HTML and CSS. At 532 the method 500 further develops the graphically represented trading blocks such that the trading blocks respond to user events and user input via the graphical user interface that include methods such as resizing and drag-and-drop. At 534, the trading blocks are developed such that they contain text and drop-down combo boxes for user selection, giving a user multiple selection choices. At 536, the trading blocks are developed such that they can resize as other blocks are attached or embedded within them. Finally, the method 500 develops the trading blocks at 538 such that the look (i.e. the appearance) of the trading blocks can be customized by the user. Customization operations include but are not limited to colors and fonts.

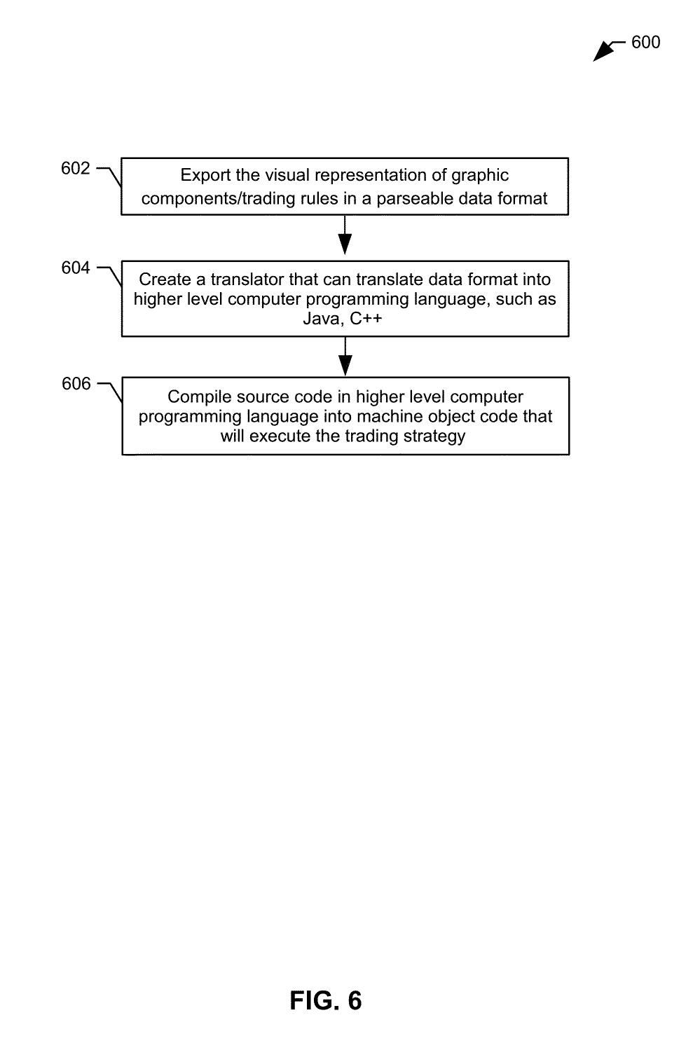

FIG. 6 is a flow diagram depicting an embodiment of a method 600 for translating the visual trading rules into executable machine object code that can be used to evaluate the trading strategy. Initially, at 602, the method 600 exports the visual representation of graphic components and/or trading rules in a parseable data format. In some embodiments, this data format contains all of the necessary states of the blocks, including connections and attachments to other blocks. At 604, the method 600 creates a translator that translates the data format into a higher level computer programming language such as Java or C++. Other higher level computer programming languages include Scala or Python. Finally, at 606, the method 600 compiles the source code in the higher level computer programming language into machine object code that will execute the trading strategy. The execution of the machine code is performed, for example, by the analytics server 112, wherein the execution of the machine code is an evaluation of the performance of the trading strategy constructed by the user.

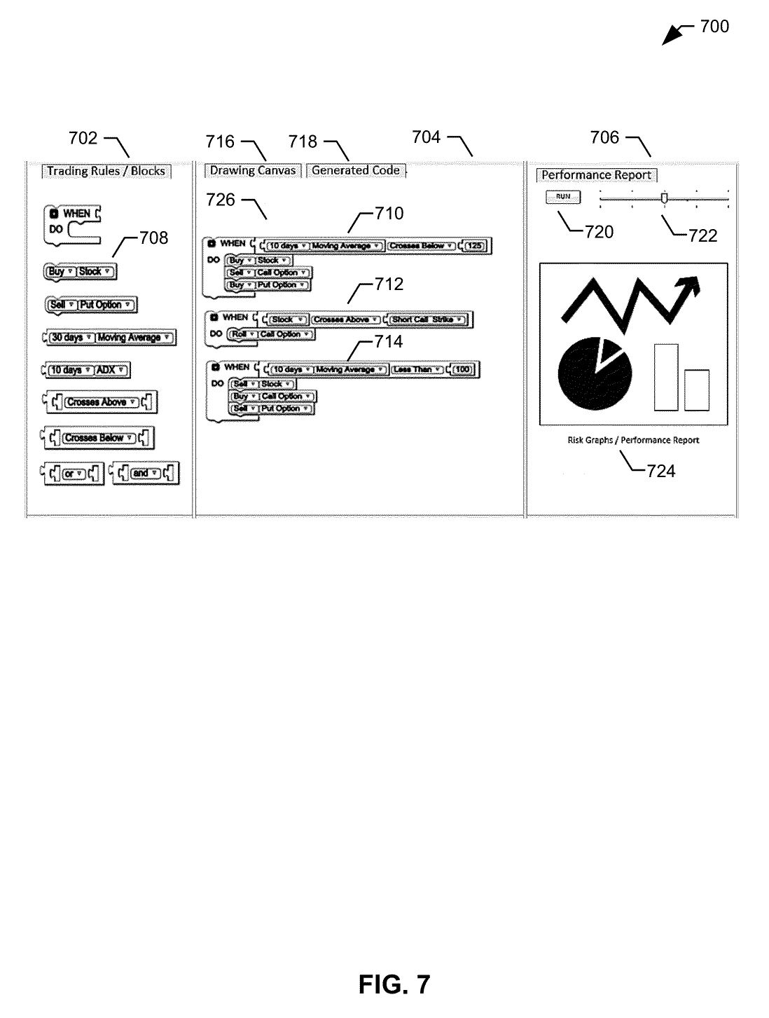

FIG. 7 illustrates an example of a graphical user interface 700 that allows users to create algorithmic trading strategies using visual drag-and-drop trading blocks. The graphical user interface 700 is rendered, for example, on a client device 102, 104 or 106. In one embodiment, the graphical user interface 700 is subdivided into three sections consisting of a left panel 702, a middle panel 704, and a right panel 706. Other embodiments may display the graphical user interface by using other layouts or subdivision formats.

The left panel 702 of the graphical user interface 700 contains trading blocks 708 that can be dragged by a user and dropped onto the middle panel 704. In one embodiment, the layout for the trading blocks 708 can be in a flat list format as depicted. Other embodiments may use different formats, such as a hierarchical tree format, for the layout of the trading blocks 708. A constructed trading strategy (represented by 710, 712,714) is displayed on the middle panel 704.

In one embodiment of the graphical user interface 700, the middle panel contains two tabs. The first tab 716 is used to display the drawing canvas 726, wherein the drawing canvas is where a user constructs a trading strategy by dragging and dropping the desired trading blocks 708. The second tab 718 is used to display the generated code, which is generated by the translation of the graphically represented constructed trading strategies into a higher level computer programming language such as Java, C++ or Scala. In the example of FIG. 7, the drawing canvas is displayed on the graphical user interface 700, while the generated code is not displayed. The method for translation of the graphically represented constructed trading strategies into a higher level computer programming language is implemented in 602 by method 600. The overall process of translating the visual trading blocks into a programming language (such as Java or Scala) involves gathering the inputs to the trading blocks and then outputting a string of code with the inputs in the correct position. In some embodiments, each trading block has its own associated code generator. Each code generator can be used to translate a specific trading block into a higher level programming language, such as Java, C++, Scala and so on. The code generator associated with each trading block can collect all the arguments and field data associated with a given trading block. For example, in the case of a text field, the associated block can return the user typed text. In the case of a dropdown, the block can return the text associated with the selected option. The code generator checks whether any of the translated outputs corresponds to reserved words in the given programming language and if so, rewrites the output to avoid collision with reserved words. The code generator has an ordered list of precedences in order to wrap the code in parentheses as required. The final code can be assembled by iterating through the stack of nested blocks, generating the code for that stack of blocks, indenting or formatting the code, and returning the code as a string. The resulting code can be compilable code in a language such as Java, C++ and so on. This code can then be compiled and executed to evaluate the trading strategy.

In one embodiment, the right panel 706 of the graphical user interface 700 contains controls that a user can apply to evaluate the performance of a constructed trading strategy. A “Run” button 720 submits a constructed trading strategy to the analytics server 112 for one-click backtesting. A slider 722 will allow the user to evaluate a constructed trading strategy against various ranges of historical market data by dragging the slider across the desired date ranges. In this way, a user can select a specific time interval over which to test the constructed trading strategy with respect to past market data.

In some embodiments, the right panel 706 also contains performance reports and risk graphs 724 corresponding to the current constructed trading strategy 710, 712, 714 defined in the drawing canvas on the middle panel 704.

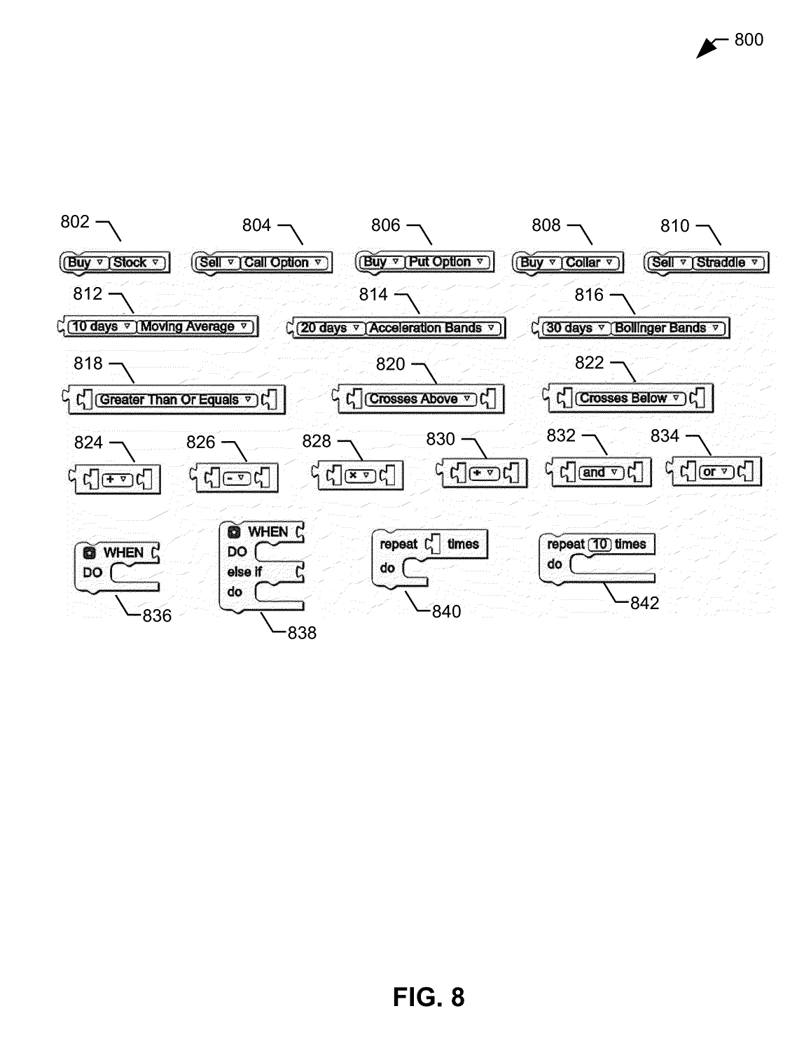

FIG. 8 illustrates an example of a visual representation 800 of the components of the graphical user interface as jigsaw puzzle-shaped trading blocks. In one embodiment, the trading blocks are depicted as being rectangular-shaped. Other embodiments may depict the trading blocks as other shapes and patterns. The trading blocks have unique grooves and patterns such that they provide visual clues as to how they can be connected with other trading blocks. Different types of trading rules may be assigned to different sets of trading blocks.

In one embodiment, trade actions and orders are represented by trading blocks 802, 804, 806 and 808. For instance, trading block 802 represents an action to buy a stock, while trading block 804 represents an action to sell a call option. Other trading blocks that represent trade actions and orders are 806, 808 and 810. Trading blocks that represent trade actions and orders can be connected together to represent the combination of multiple trade orders, as represented by 710 (FIG. 7). Technical studies are illustrated by trading blocks 812, 814 and 816. For example, trading block 812 represents the “10 day moving average” of a stock or other item. Trading blocks corresponding to technical studies can be connected to trading blocks 818, 820, 822 corresponding to comparison or equality operators. For example, trading block 818 corresponds to the “Greater Than Or Equals” operator.

An example of a mathematical operation is illustrated by trading block 824. In some embodiments, mathematical operations include but are not limited to addition, subtraction, multiplication and division, represented by trading blocks 824, 826, 828 and 830, respectively. Trading blocks 812, 814, 816 corresponding to technical studies can be placed within trading blocks 824, 826, 828, and 830 corresponding to mathematical operations to express the mathematical transformation of technical studies.

Trading blocks corresponding to logical operators are represented by trading blocks 832 and 834. These trading blocks represent the ability to perform Boolean operations such as “AND” or “OR” operations on various trading rules. In other embodiments, additional logical operators may be provided by additional trading blocks.

Conditional trading rules are represented by trading blocks 836 and 838. Trading blocks corresponding to conditional trading rules can be used to perform specific trading actions only when specific events or market conditions are met. Loops are represented by trading blocks 840, 842. Trading blocks corresponding to loops allow the repetitive evaluation of several trading rules and actions.

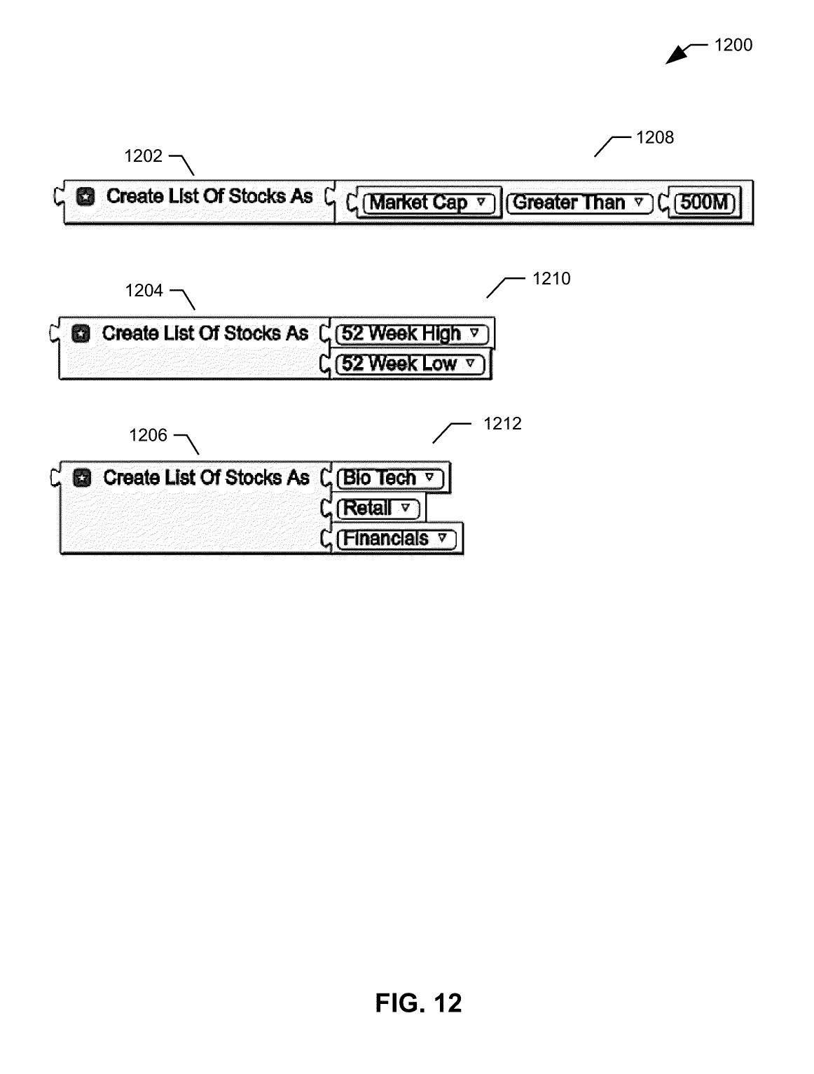

Other embodiments may include trading blocks corresponding to lists (shown in FIG. 12), wherein these trading blocks can be used to select a list of stocks that meet specific criteria. For example, a list of stocks in which the market capitalization of the company exceeds $500M can be created using a trading block corresponding to lists.

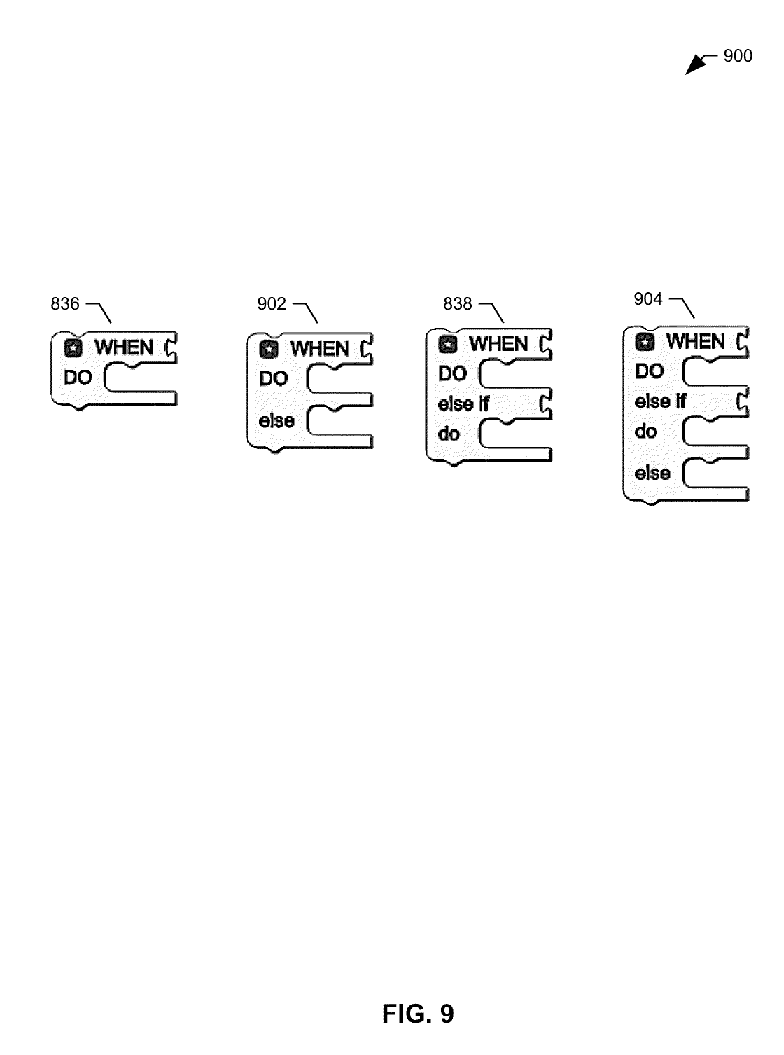

FIG. 9 depicts an example of a visual representation 900 of conditional trading rules as components of the graphical user interface. Trading block 836 corresponds to a WHEN/DO conditional trading rule such that WHEN an even happens, the block causes the trading system to DO a trade action. In some embodiments, trading block 836 corresponds to a WHEN/DO conditional trading rule can be used as follows:

WHEN [10 day Moving Average 812] [Crosses Above 820] [20 day Moving Average 814] DO [Buy Stock 802].

Other variations of trading blocks corresponding to the WHEN/DO trading rule are 838, 902, and 904. Trading block 902 corresponds to the WHEN/DO/ELSE trading rule, while trading blocks 838 and 904 correspond to the WHEN/DO/ELSE IF/DO and WHEN/DO/ELSE IF/DO/ELSE trading rules respectively.

The trading blocks 836, 838, 902 and 904 corresponding to conditional trading rules can be connected to various trading blocks corresponding to other trading rules, including trading blocks 832 and 834 corresponding to logical operators, trading blocks 818, 820 and 822 corresponding to comparison operators, or trading blocks 802, 804, 806, 808 and 810 corresponding to trade actions.

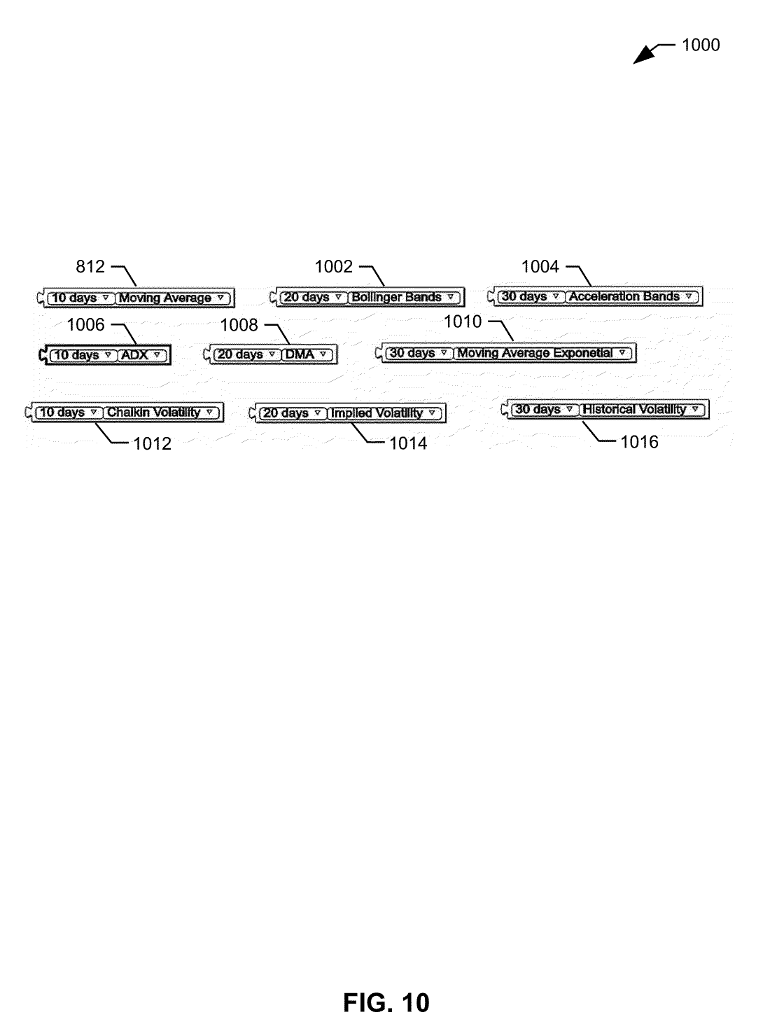

FIG. 10 depicts an example of a visual representation 1000 of market studies. Market studies include, but are not limited to, technical studies, fundamental studies, volatility studies and statistical studies. In an embodiment, the visual representation 1000 of market studies includes the trading block 812 corresponding to the trading rule “10 day Moving Average,” the trading block 1002 corresponding to the trading rule “20 day Bollinger Bands,” the trading block 1004 corresponding to the trading rule “30 day Acceleration Bands,” the trading block 1006 corresponding to “10 day ADX,” the trading block 1008 corresponding to “20 day DMA”, the trading block 1010 corresponding to “30 day Moving Average Exponential,” the trading block 1012 corresponding to “10 day Chaikin Volatility,” the trading block 1014 corresponding to “20 day Implied Volatility,” and the trading block 1016 corresponding to “30 day Historical Volatility.” Trading blocks 812, 1002, 1004, 1006, 1008, 1010, 1012, 1014 and 1016 are some of the trading blocks corresponding to market studies.

Trading blocks corresponding to market studies can be connected to other trading blocks, such as trading blocks 832, 834 corresponding to logical operators, and trading blocks 824, 826, 828 and 830 corresponding to mathematical operations.

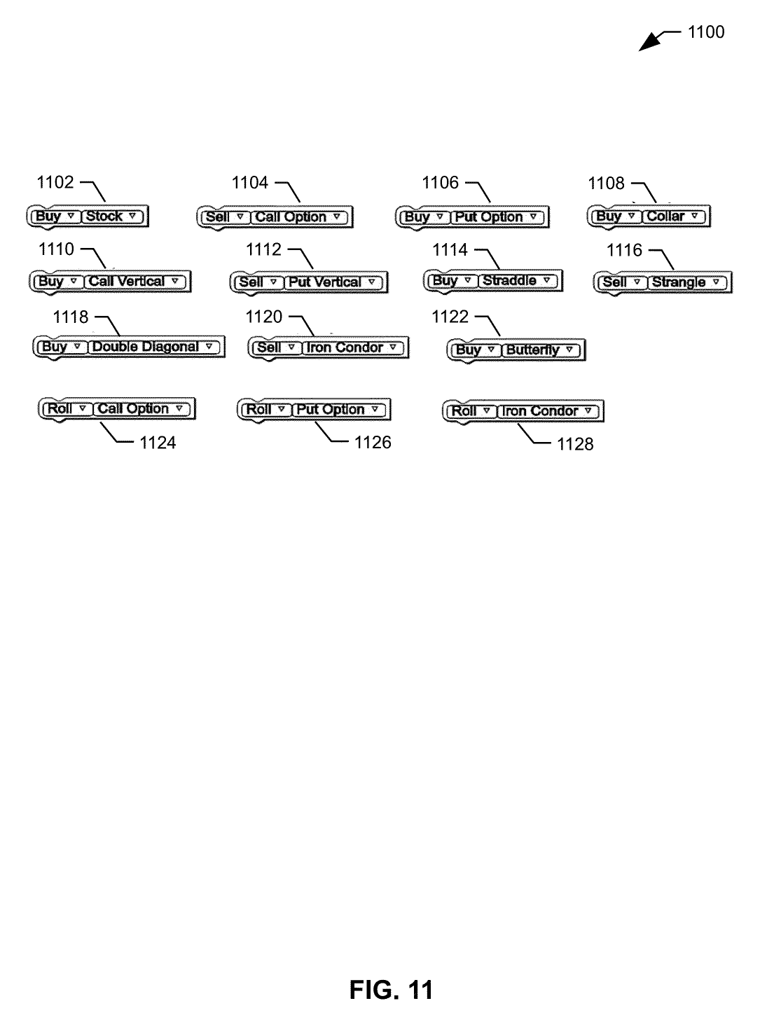

FIG. 11 illustrates an example of a visual representation 1100 of various types of trade actions. Trading block 1102 corresponds to the trade action of buying a stock, while trading block 1104 corresponds to the trade action of selling a call option. Trading blocks 1108, 1110, 1118 and 1120 correspond to complex spread orders, while trading blocks 1124 and 1126 correspond to actions to roll an existing leg or position. Other trading blocks corresponding to other types of trade actions are 1106, 1112, 1114, 1116, 1122 and 1128. The trading blocks corresponding to various types of trade actions can be connected to other trading blocks, such as trading blocks corresponding to various types of trade actions, including trading blocks 836, 838, 902 and 904 corresponding to conditional operators and trading blocks 840 and 842 corresponding to loops.

FIG. 12 illustrates an example visual representation 1200 of creating a list of stocks to trade based on specific criteria. The visual representation 1200 includes trading block 1202 corresponding to lists, of an algorithmic trading strategy 1208 to create a list of stocks whose market capitalization is greater than $500M. The visual representation 1200 includes trading block 1204 corresponding to lists, of an algorithmic trading strategy 1210 to create a list of stocks which are either at their 52 week highs or their 52 week lows. The visual representation 1200 also includes trading block 1206 corresponding to lists, of an algorithmic trading strategy 1212 to create a list of stocks from the Bio Tech, Retail and Financials industries.

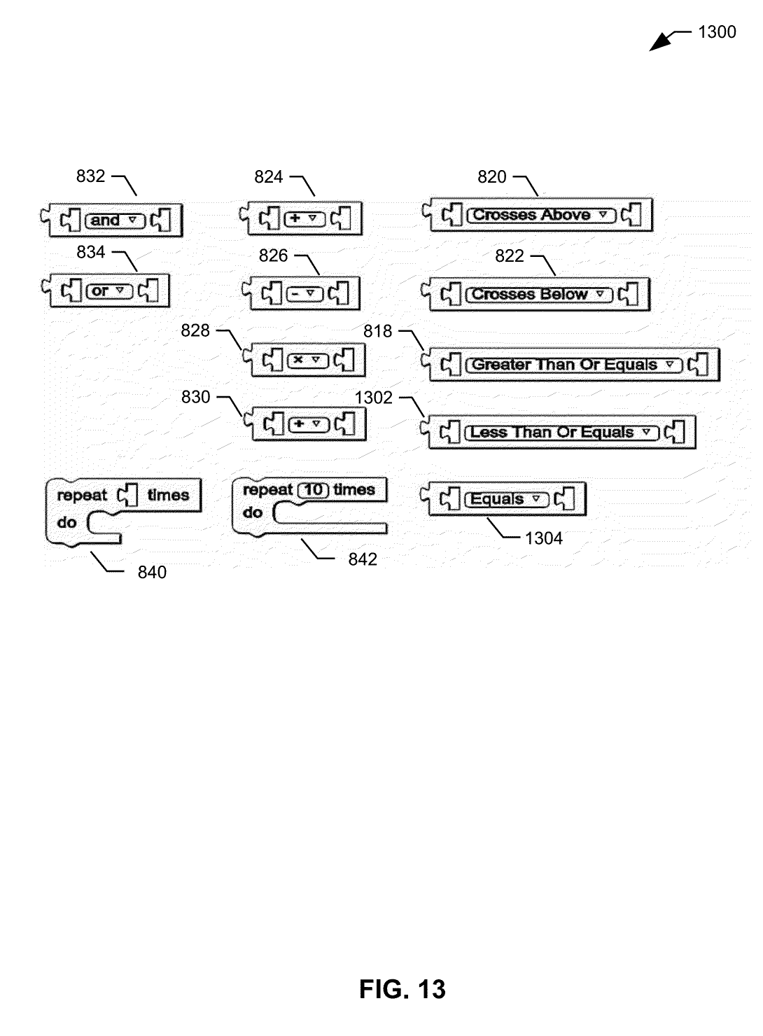

FIG. 13 depicts an example visual representation 1300 of various general programming constructs. Logical operators such as “AND” and “OR” rules are represented by trading blocks 832 and 834, respectively. Mathematical operations such as addition, subtraction, multiplication and division are represented by trading blocks 824, 826, 828 and 830, respectively. Trading blocks 820, 822, 818, 1302, and 1304 correspond to the comparison/equality operations “Crosses Above,” “Crosses Below,” “Greater Than Or Equals,” “Less Than or Equals,” and “Equals,” respectively. Trading blocks 832 and 834 correspond to logical operators that can be placed within trading blocks 820, 822, 818, 1302, and 1304 corresponding to comparison/equality operations to join together complex trading rules.

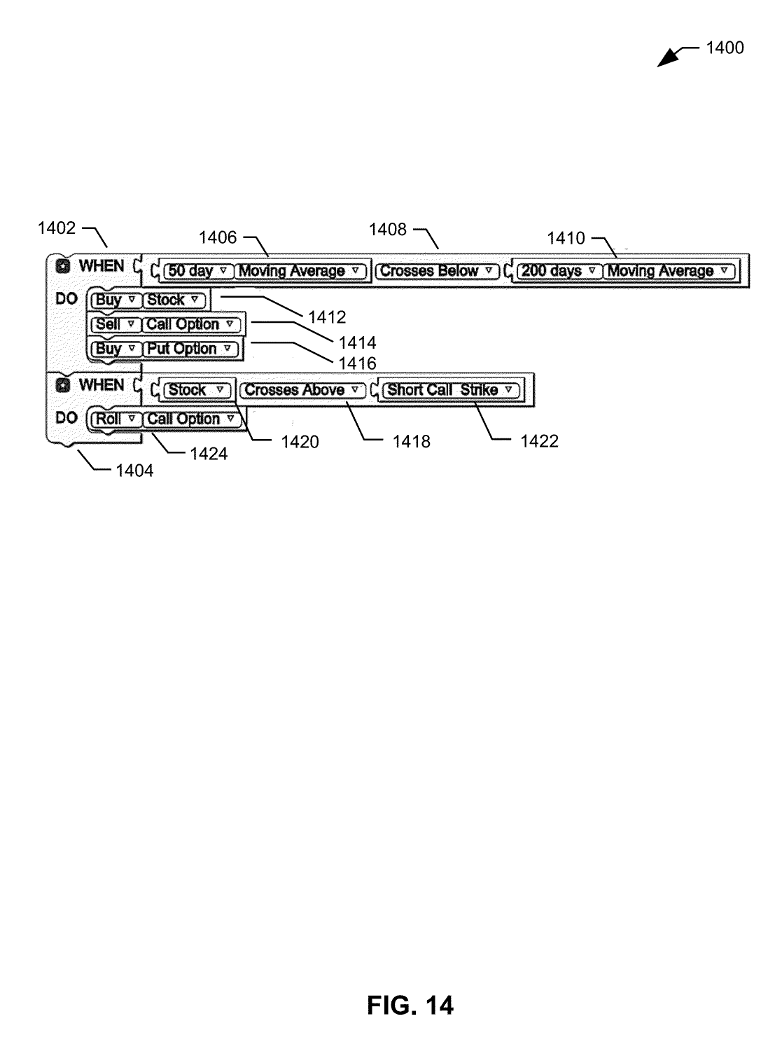

FIG. 14 depicts an example visual representation 1400 of a complex trading rule by connecting various trading blocks together. The figure illustrates the following trading rules:

WHEN [50 day Moving Average] [Crosses Below] [200 day Moving Average]
Buy Stock
Sell Call Option
Buy Put Option

WHEN [Stock] [Crosses Above] [Short Call Strike Price]
Roll Call Option

In this example trading rule, the trader would like to Buy a Collar (Buy Stock, Sell Call Option, Buy Put Option) whenever the 50 day Moving Average crosses below the 200 day Moving Average. But if the stock price increases and crosses above the strike price of the short call, the trader would like to roll the call option further out of the money. The steps to construct this trading strategy using the various blocks are as follows:

Drag and drop a WHEN/DO trading block 836 from the left panel 702 of the graphical user interface to the drawing canvas 726 on the middle panel 704 to construct the first WHEN/DO trading block 1402.

Drag and drop a comparison trading block 822 corresponding to “Crosses Below” from the left panel 702 of the graphical user interface 700 to the drawing canvas 726 on the middle panel 704. Attach this comparison trading block 822 to the WHEN/DO trading block 1402 to construct the comparison trading block 1408.

Drag and drop a “Moving Average” trading block 812 from the left panel 702 of the graphical user interface 700 to the drawing canvas 726 on the middle panel 704. Place this trading block 812 on top of the open slot on the LEFT side of the trading block 1402. Adjust the number of days to 50 days to construct the trading block 1406.

Drag and drop a “Moving Average” trading block 812 from the left panel 702 of the graphical user interface 700 to the drawing canvas 726 on the middle panel 704. Place this trading block 812 on top of the open slot on the RIGHT side of the trading block 1402. Adjust the number of days to 200 days to construct the trading block 1410.

Drag and drop a “Buy Stock” trading block 802 from the left panel 702 of the graphical user interface 700 to the drawing canvas 726 on the middle panel 704. Place this trading block 802 in the “mouth” of the trading block 1402 to construct the trading block 1412.

Drag and drop a “Sell Call Option” trading block 804 from the left panel 702 of the graphical user interface 700 to the drawing canvas 726 on the middle panel 704. Place this trading block 804 in the “mouth” of the trading block 1402 right below the trading block 1412 to construct the trading block 1414.

Drag and drop a “Buy Put Option” trading block 806 from the left panel 702 of the graphical user interface 700 to the drawing canvas 726 on the middle panel 704. Place this trading block 806 in the “mouth” of the trading block 1402 right below the trading block 1414 to construct the trading block 1416.

Drag and drop a WHEN/DO trading block 836 from the left panel 702 of the graphical user interface to the drawing canvas 726 on the middle panel 704. Place this trading block 836 below the first WHEN/DO trading block 1402 to construct the second WHEN/DO trading block 1404.

Drag and drop a comparison trading block 820 corresponding to “Crosses Above” from the left panel 702 of the graphical user interface 700 to the drawing canvas 726 on the middle panel 704. Attach this comparison trading block 820 to the WHEN/DO trading block 1404 to construct the comparison trading block 1418.

Drag and drop a trading block corresponding to “Stock” from the left panel 702 of the graphical user interface 700 to the drawing canvas 726 on the middle panel 704. Place this trading block on the LEFT side of the open slot of the comparison trading block 1418 to construct the trading block 1420.

Drag and drop a trading block corresponding to “Short Call Strike” from the left panel 702 of the graphical user interface 700 to the drawing canvas 726 on the middle panel 704. Place this trading block on the RIGHT side of the open slot of the comparison trading block 1418 to construct the trading block 1422.

Drag and drop a trading block corresponding to “Roll Call Option” from the left panel 702 of the graphical user interface 700 to the drawing canvas 726 on the middle panel 704. Place this trading block in the “mouth” of the trading block 1404 right below the trading block 1418 to construct the trading block 1424.

Once the trading strategy of FIG. 14 has been constructed, the trading strategy can be submitted to the analytics server 112 for evaluation with one click of the Run button 720.

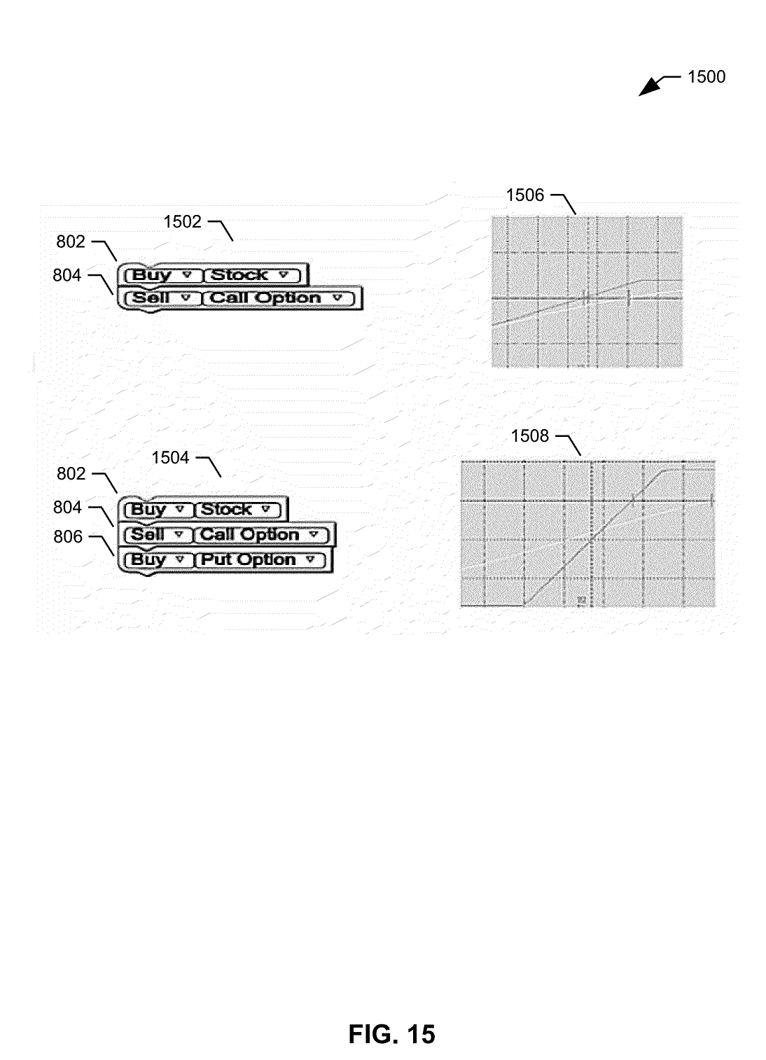

FIG. 15 illustrates a visual representation 1500 showing an example of how the graphical user interface dynamically updates a risk graph associated with a particular spread as the spread is modified. 1502 is an example trading strategy constructed by combining trading blocks 802 (Buy Stock) and 804 (Sell Call Option), and 1506 shows the corresponding risk graph, which represents the risk graph of a Covered Spread (Buy Stock, Sell Call Option). If an additional trading block 806 (Buy Put Option) is added to the trading strategy 1502 to form a modified trading strategy 1504, risk graph 1506 is correspondingly updated and displayed as the updated risk graph 1508, representing a Collar Spread (Buy Stock, Sell Call Option, Buy Put Option).

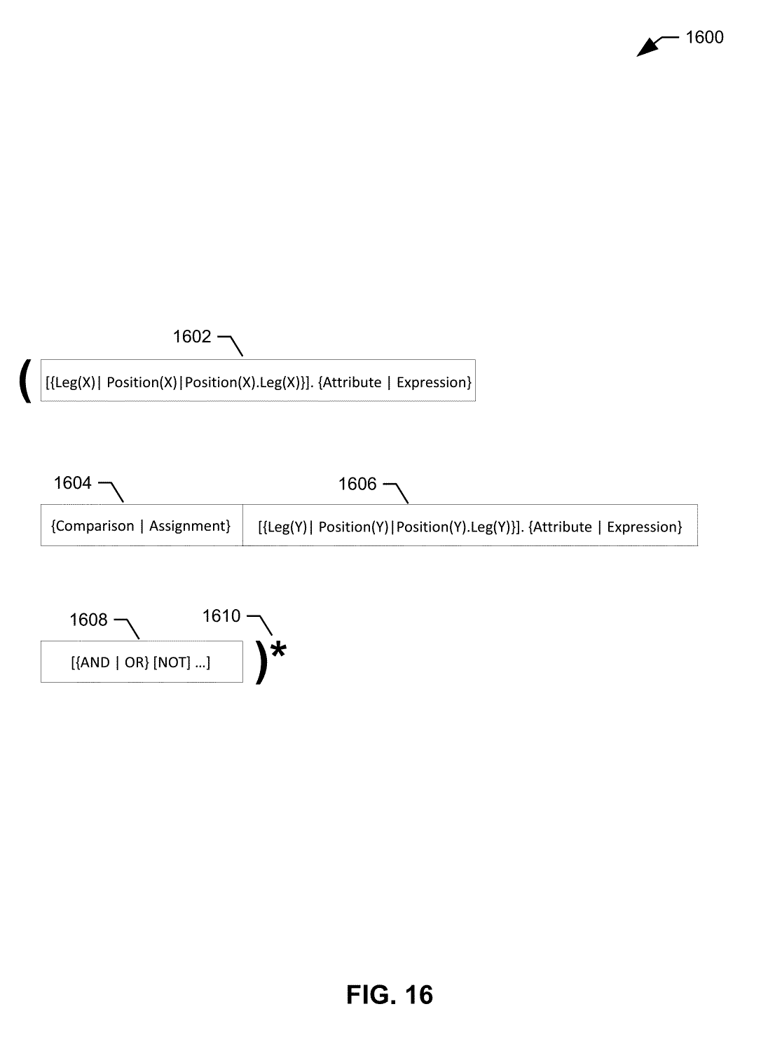

FIG. 16 illustrates an example visual representation 1600 of the construction of a multi-legged option spread. A complex option spread contains two or more legs. Each leg can have its own strike price, expiration date, quantity, long or short, and so on. For instance, a collar may consist of a spread consisting of a long stock, a short “out of the money” call option, and a long “at-the-money” put option. The visual representation 1600 of the multi-legged option spread is constructed based on a syntactical representation of the complex relationships among the different legs.

The challenge is to define a method to allow the expression of such complex relationships among the different legs. One method of expressing such rules is to create a domain specific language (DSL) with a syntax similar to the following:

[{Leg(x)|Position(x)|Position(x).Leg(x)}]. {Attributes|Expressions}

{==|>|<|!=, >=|<=, :=, . . . } “Compare or Assign”

[{Leg(y)|Position(y)|Position(y).Leg(y)}]. {Attributes|Expressions}

{AND|OR|NOT} “Logical Operators”

SortBy {Attributes} {ASC|DESC} “Sort Criteria”

Choose {Integer} “Choose Top X”

Set Quantity { } “Size the spread based on user-defined criteria such as risk, cost, margin and so on.

In the above set of equations, Leg(x) refers to a specific leg of the current spread, such as Leg 1, Leg 2, Leg 3. Position(x) refers to the current position or a separate position. A position can be composed of one or more legs. Position(x).Leg(x) refers to a specific leg of the current position or separate position. “Attributes” refers to any set of attributes related to the option, leg and/or position, including but not limited to strike price, days to expiration, delta, gamma, theta, vega, quantity, long or short, risk/reward, margin and so on. “Expression” refers to any combination of one or more values, operators, attributes, functions that evaluate to a single value. Simple expressions can be a single constant, attribute, variable or scalar function. “Logical Operators” can be used to join two or more simple expressions into a complex expression. “Comparison” conditions define the equality relationships between the different legs and attributes, including but not limited to “greater than,” “less than,” “equal to,” and “not equal to.” “Assignment” refers to setting the value on the left side of the assignment operator equal to the value on the right side of the operator. “Logical Operators” define the logical relationships, including but not limited to AND, OR, NOT.

As shown in FIG. 16, a user adds pairs of legs and/or positions attributes with comparisons or assignments as needed at 1602 and 1606. Comparison operators include “==”, “<=”, “<”, “>”, “>=”, and so on. Assignment operators are used to set a value to a specific variable. Comparison and/or assignment operators are implemented in 1604. Logical operators such as AND, OR and NOT are shown in 1608. 1610 is a construct that instructs the method to repeat the rules one or more times.

Presented is an example of how to construct a 3-legged collar spread, as displayed by risk graph 1508, using the domain specific language syntax discussed above. This 3-legged collar spread consists of short out of the money call options (Leg 1), long out of the money put options (Leg 2), and long stock (Leg 3). Using the domain specific language method discussed above, presented here is a “zero-cost” collar with at least 50 days to expiration, with the short call at least 10% out of the money, and with a risk/reward ratio of at least 50%. If multiple collars spread match the criteria, the spreads are ranked by the maximum risk, and the spread with the lowest risk is selected. The position is also sized to have $50,000 in maximum risk.

1) Leg(“1”):=Short×1 [Leg 1 assigned a short position with a ratio of 1]

AND

2) Leg(“2”):=Long×1 [Leg 2 assigned a long position with a ratio of 1]

AND

3) Leg (“1”).DaysToExpiration>50 days [Leg 1 “Days To Expiration” must be greater than 50 days]

AND

4) Leg(“2”).Expiration==Leg(“1”).Expiration [Leg 1 and Leg 2 should have the same option expiration date]

AND

5) Leg(“1”).StrikePrice>=Leg(“3”).Price*1.10 [Leg 1 strike price should be at least 10% “out of the money”—short call should be at least 10% out of the money]

AND

6) Leg(“2”).DebitCost<=Leg(“1”).CreditCost [Leg 2 (long put) debit cost must be less than the credit received from Leg 1 (short call). “Zero-cost dollar.”]

AND

7) OverallPosition.RiskReward>=50% [The overall collar position should have a risk/reward of at least 50%]

AND

8) Sort BY Max Risk Asc [Sort all spreads by Max Risk in ascending order, starting with the lowest risk at the top of the list and highest risk at the bottom of the list]

AND

9) Choose 1 [Select top 1 spread from the sorted list, which will be the spread with the lowest risk]

AND

10) SetQuantity (Risk=$50,000) [Size the position so that position risk is $50,000]

The rules above will construct a zero-cost collar with at least 50 days to expiration, with short call option at least 10% out the money, with overall risk/reward ratio of at least 50%. If multiple spreads match these criteria, the spread with the lowest risk will be selected. Then size the selected spread so that the total risk of the spread is $50,000.

As the user types the rules, the application may provide auto-complete suggestions to guide the user through the rule creation. Furthermore, the application may provide real-time, static compile-type checks to ensure that the rules are free of syntax errors and properly defined.

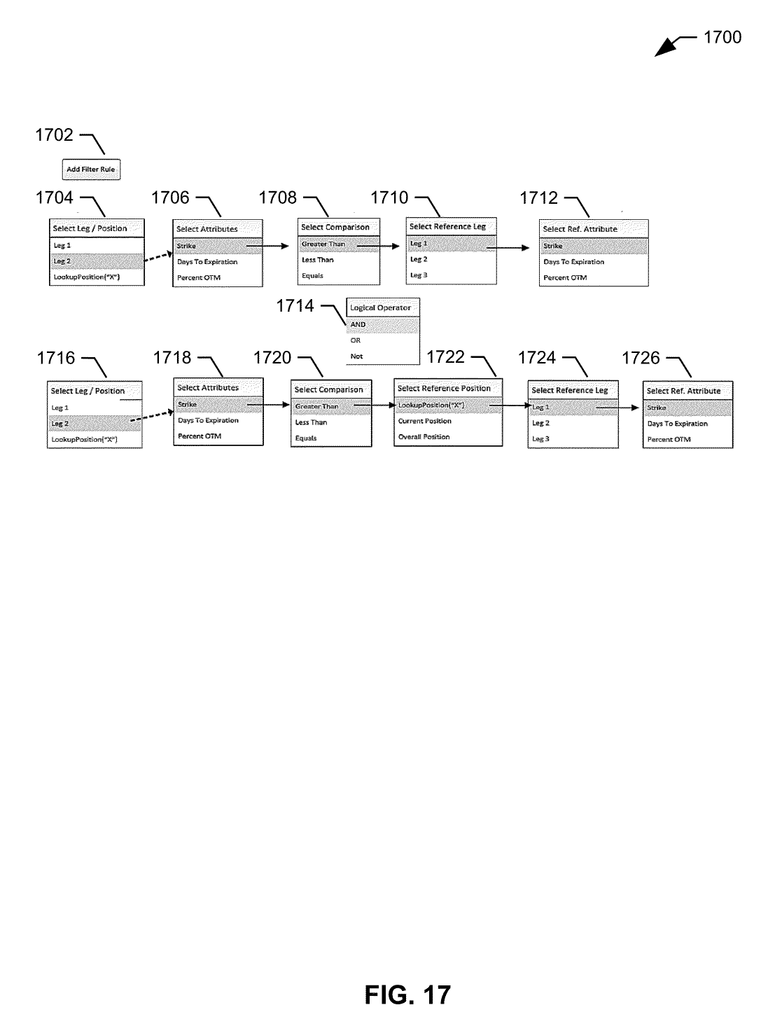

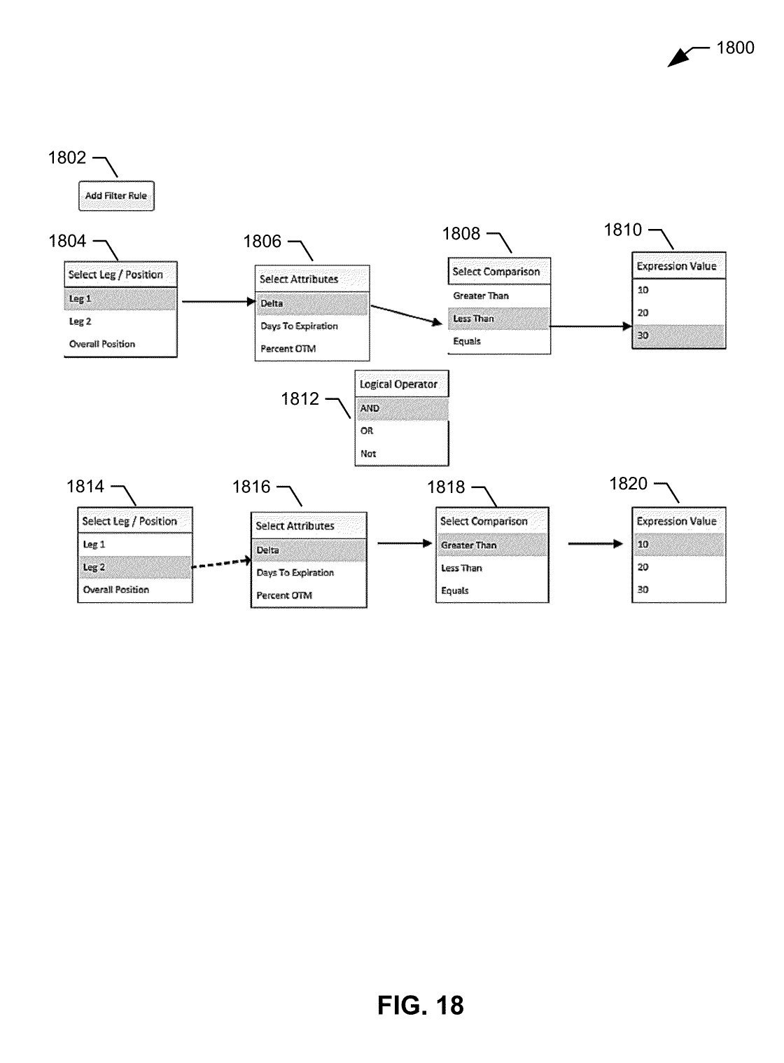

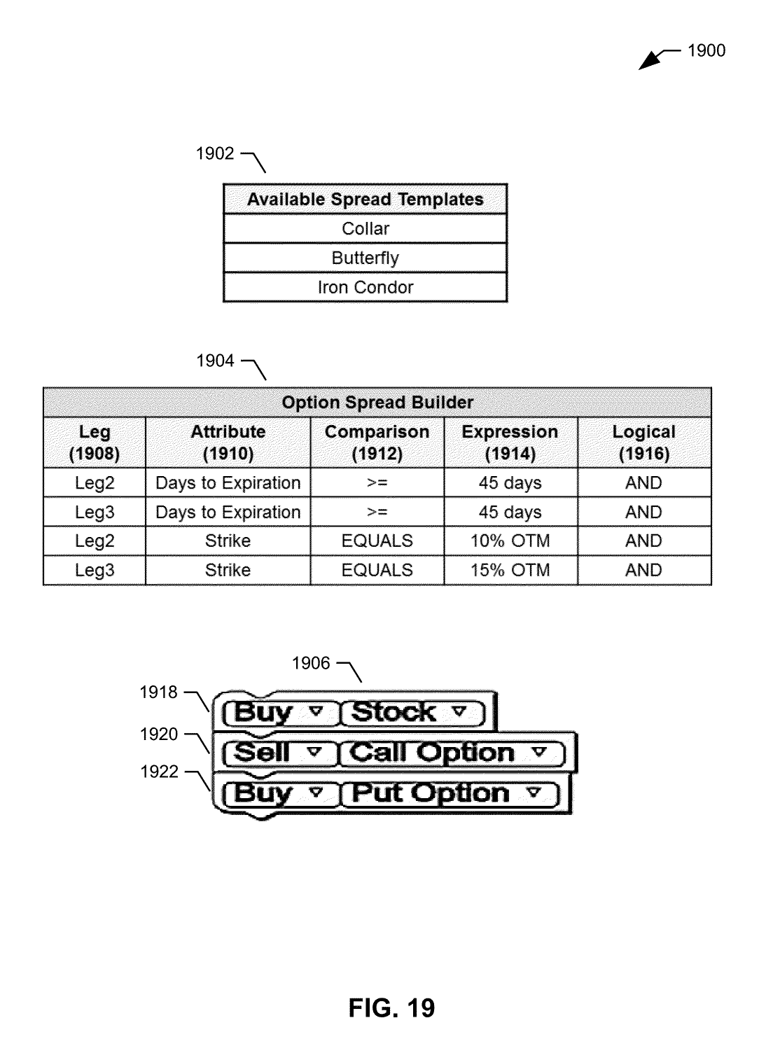

The domain specific language method discussed above is one example that allows the creation of a rules-based approach to construction complex option spreads. FIG. 17, FIG. 18 and FIG. 19 depict different graphical implementations of algorithmic trading strategies based on a domain specific language approach.

FIG. 17 depicts an example visual representation 1700 of how a user may define the rules to create complex option spreads. The user starts the process by adding a filter rule via the “Add Filter Rule” button 1702. The user is then prompted to select the leg and/or position, 1704 and to select the desired attributes for that leg 1706. The user then selects the comparison operator 1708, and the corresponding reference leg 1710, along with a reference attribute 1712. If the user wishes to add another rule, the user selects the logical operator 1714 and adds the next rule by using the “Add Filter Rule” button 1702. In the next rule, the user selects a leg and/or position 1716. Next, the user is prompted to select the desired attributes for that leg 1718. The user then selects the comparison operator 1720, and the selects a reference position 1722, after which the user selects the reference leg 1724 and the reference attribute 1726.

In this example, the user has constructed the following rules:

Leg(“2”).Strike>=Leg(“1”).Strike [Leg 2's strike price must be greater than Leg 1's strike price]

AND

Leg(“2”).Strike>=Position(“X”).Leg(“1”).Strike [AND Leg 2's strike price must also be greater than Position X—Leg 1's strike price]

FIG. 18 depicts another example visual representation 1800 of how a user may define the rules to create complex option spreads. The user starts the process by adding a filter rule via the “Add Filter Rule” button 1802. The user is then prompted to select the leg and/or position, 1804 and to select the desired attributes for that leg 1806. The user then selects the comparison operator 1808, and the expression value 1810. If the user wishes to add another rule, the user selects the logical operator 1812 and adds the next rule by using the “Add Filter Rule” button 1802. In the next rule, the user selects a leg and/or position 1814. Next, the user is prompted to select the desired attributes for that leg 1816. The user then selects the comparison operator 1818, and the selects the expression value 1820.

In this example, the user has constructed the following rules:

Leg(“1”).Delta<30 [Leg 1's Delta must be less than 30]

AND

Leg(“2”).Delta>10 [AND Leg 2's Delta must be greater than 10]

FIG. 19 illustrates an example visual representation 1900 of how users can create complex option spread strategies. In one embodiment, various option spread templates 1902 are pre-defined. A user can select any one of the option spread templates, such as butterflies, condors and so on. Once the user has selected a template, a spread builder interface 1904 will be pre-populated with rules that are relevant to customizing that specific spread.

The spread builder interface 1904 may be composed of a grid or table where each column in the grid contains a drop-down combo box. A “combo box” is a graphical element of the graphical user interface that allows a user to make a single selection from one or more options that are displayed when the graphical element is clicked on by the user. In the example of FIG. 19, a first column 1908 is where the user can select the different legs/positions. A second column 1910 allows the user to select the different attributes, including but not limited to “Days to Expiration,” “Strike,” and so on. A third column 1912 allows the user to define the comparison operator, including but not limited to “greater than,” “less than,” and so on. A fourth column 1914 may contain expressions, such as “10% OTM,” “45 days to expiration,” and so on. If a user wants to add multiple rules, the user can select the logical operator such as an AND or an OR operator in a fifth column 1916. Users keep repeating the process until all the rules have been defined. Also shown in FIG. 19 is the constructed trading rule 1906 and the associated three legs 1918, 1920 and 1922.

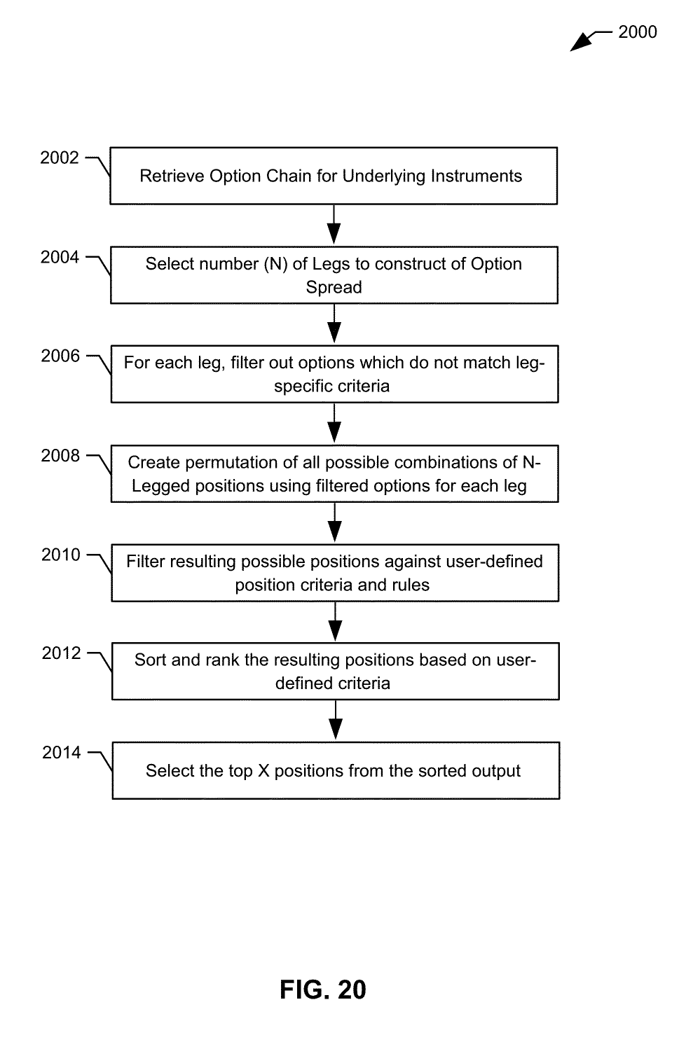

FIG. 20 represents a flow diagram depicting an embodiment of a method 2000 for executing the rules used to construct the user-defined option spreads. Initially, the method 2000 retrieves the option chain for the underlying instruments at 2002. This retrieval is done for a particular date. Next, at 2004, the method 2000 selects the number of legs to construct for the option spread. At 2006, for each leg, the method 2000 filters out options which do not match leg-specific criteria. Next, at 2008, the method 2000 creates a permutation of all possible combinations of N-legged positions using the filtered options for each leg. The resulting possible positions are filtered against user-defined position criteria and rules at 2010. Here, spreads that do not meet all user-defined criteria are eliminated. At 2012, the resulting positions are sorted and ranked based on user-defined criteria, wherein the criteria include, but are not limited to, Risk/Reward Ratio, Cost, Credit Received, Margin, Delta and so on. Finally, at 2014, the top X positions are selected from the sorted output list, wherein X is a number defined by the user. For example, if the spread construction rules generate a list of 20 spreads which satisfy all the trading rules, select the one spread that has the highest risk/reward ratio.

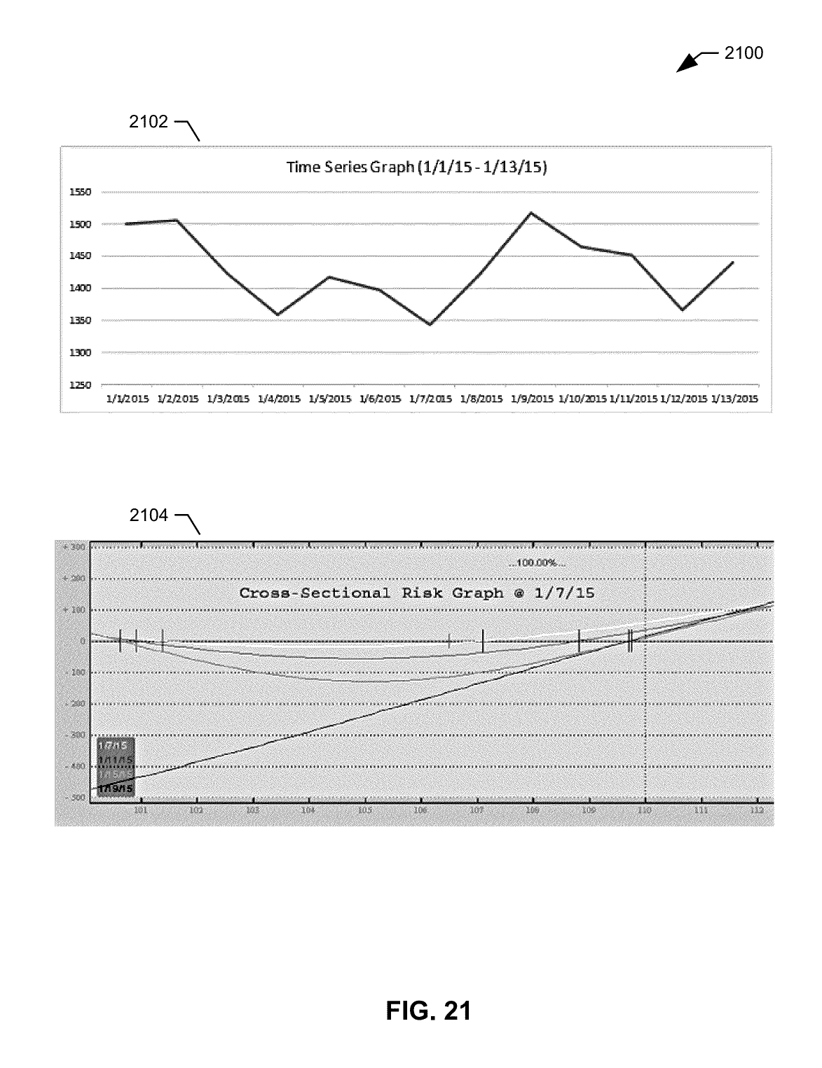

FIG. 21 depicts an alternative method of displaying the results from the testing of an algorithmic trading strategy to a user 2100. In some embodiments, the results of the testing of an algorithmic trading strategy may be presented as some combination of time series data and cross-sectional data, wherein time series data represents a time series of any metric associated with an algorithmic trading strategy such as profit/loss, option greeks, risk and so on, and cross-sectional data represents the detailed values of one or more metrics at a specific point or cross-section in time. In some embodiments, the time series data and cross-sectional data can be displayed as graphical plots. 2102 is an example of a time series data plot representing the profit/loss of an algorithmic trading strategy from Jan. 1, 2015 to Jan. 13, 2015, while 2104 is an example of a cross-sectional data plot corresponding to the algorithmic trading strategy whose profit/loss is represented by the time series data plot 2102. In some embodiments, the X-axis of the time series data plot 2102 represents different points in time and the Y-axis represents the value of a particular metric at a point in time. The cross-sectional data plot 2104 represents the profit/loss of the portfolio at Jan. 7, 2015 if the underlying had moved anywhere from 101 to 110. The cross-sectional data plot 2104 also depicts the profit/loss at multiple time frames (1/15, 1/19), based on assumptions about the market environment that include but are not limited to volatility, interest rates and so on Jan. 7, 2015.

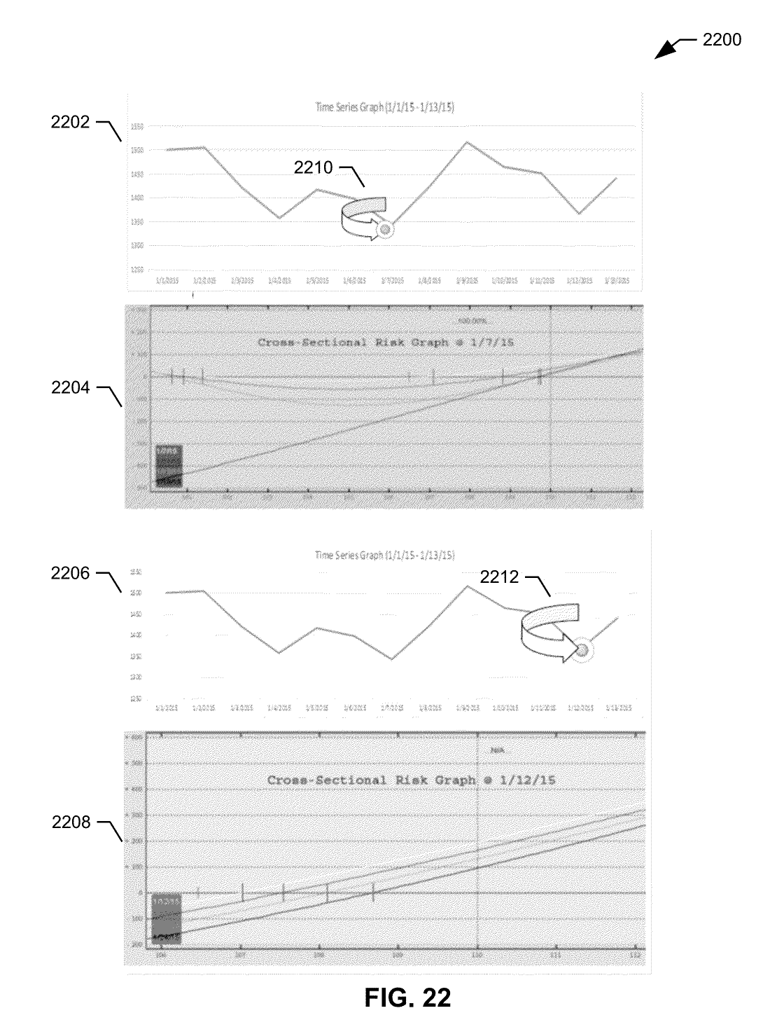

FIG. 22 depicts another alternative method of displaying the results from the testing of an algorithmic trading strategy to a user 2200. This method relates to the time series data plot and the corresponding cross-sectional data plot associated with an algorithmic trading strategy. In some embodiments, as the user interacts with the time series data plot, the cross-sectional data plot gets updated with the selection from the time series data plot. For example, if a user selects different dates on the time series data plot, the corresponding dates on the cross-sectional data plot get updated. 2202 is a time series data plot, and 2204 is the cross-sectional data plot associated with the selected date Jan. 7, 2015 depicted by marker 2210. If a user now updates the time series data plot by changing the selected date to Jan. 12, 2015 as depicted by marker 2212, on the time-series data plot 2206, the cross-sectional data plot 2208 dynamically updates to provide a detailed cross-section of specific metrics for that specific time series point 2212.

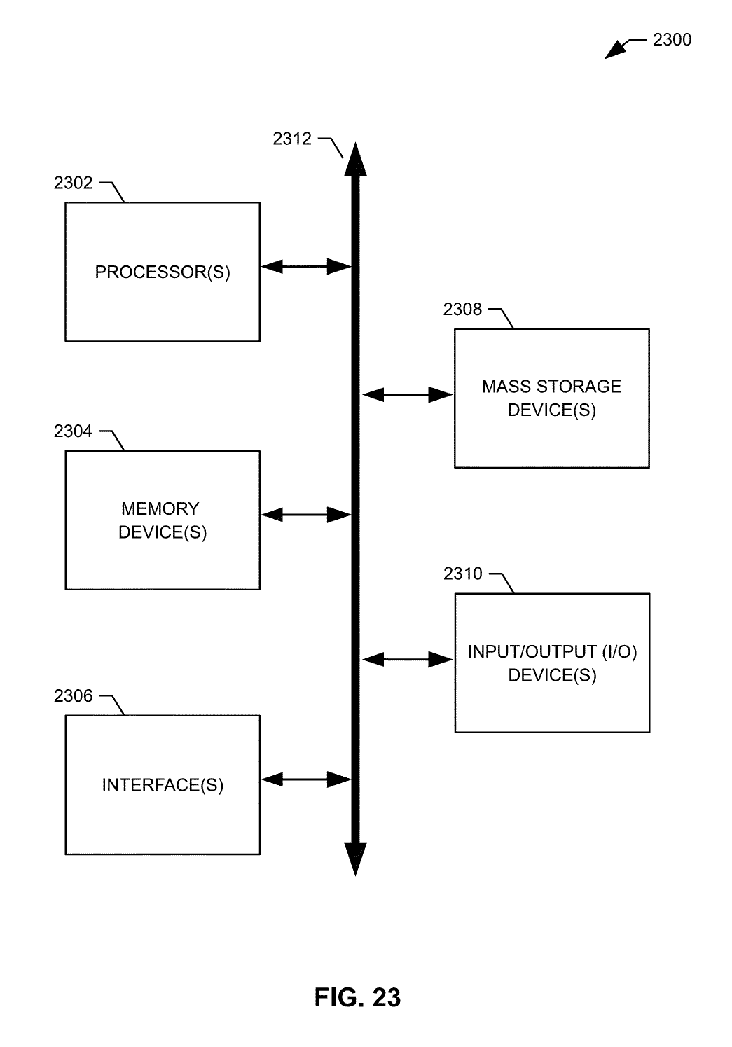

FIG. 23 shows an example computing device 2300 capable of implementing the methods and techniques discussed herein. Computing device 2300 may be used to perform various procedures, such as those discussed herein. Computing device 2300 can function as a server, a client or any other computing entity. Computing device 2300 can be any of a wide variety of computing devices, such as a desktop computer, a notebook computer, a server computer, a handheld computer, a tablet, and the like.

Computing device 2300 includes one or more processor(s) 2302, one or more memory device(s) 2304, one or more interface(s) 2306, one or more mass storage device(s) 2308, and one or more Input/Output (I/O) device(s) 2310, all of which are coupled to a bus 2312. Processor(s) 2302 include one or more processors or controllers that execute instructions stored in memory device(s) 2304 and/or mass storage device(s) 2308. Processor(s) 2302 may also include various types of computer-readable media, such as cache memory.

Memory device(s) 2304 include various computer-readable media, such as volatile memory (e.g., random access memory (RAM)) and/or nonvolatile memory (e.g., read-only memory (ROM)). Memory device(s) 2304 may also include rewritable ROM, such as Flash memory.

Mass storage device(s) 2308 include various computer readable media, such as magnetic tapes, magnetic disks, optical disks, solid state memory (e.g., Flash memory), and so forth. Various drives may also be included in mass storage device(s) 2308 to enable reading from and/or writing to the various computer readable media. Mass storage device(s) 2308 include removable media and/or non-removable media.

I/O device(s) 2310 include various devices that allow data and/or other information to be input to or retrieved from computing device 2300. Example I/O device(s) 2310 include cursor control devices, keyboards, keypads, microphones, monitors or other display devices, speakers, printers, network interface cards, modems, lenses, CCDs or other image capture devices, and the like.

Interface(s) 2306 include various interfaces that allow computing device 2300 to interact with other systems, devices, or computing environments. Example interface(s) 2306 include any number of different network interfaces, such as interfaces to local area networks (LANs), wide area networks (WANs), wireless networks, and the Internet.

Bus 2312 allows processor(s) 2302, memory device(s) 2304, interface(s) 2306, mass storage device(s) 2308, and I/O device(s) 2310 to communicate with one another, as well as other devices or components coupled to bus 2312. Bus 2312 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 2300, and are executed by processor(s) 2302. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A computer-implemented method comprising:
presenting, using one or more processors, components of algorithmic trading strategies to a user, the components including declarative rules and expressions;
receiving data associated with a trading strategy generated by the user with the declarative rules and expressions;
receiving a time interval from the user;
compiling, using the one or more processors, the data associated with the trading strategy based on past market data;
testing, using the one or more processors, the algorithmic trading strategy referenced to the time interval; and
communicating the results of the testing to the user.

2. The method according to claim 1, wherein presenting components of algorithmic trading strategies includes presenting a graphical user interface to the user such that the graphical user interface supports interactive creation of a specific algorithmic trading strategy.

3. The method according to claim 2, wherein the selection of a time period over which to evaluate the performance of an algorithmic trading strategy is done by the user via the graphical user interface.

4. The method according to claim 2, wherein an algorithmic trading strategy is constructed by dragging and dropping a plurality of graphic components associated with the graphical user interface, wherein the graphic components represent at least one of declarative rules, expressions, and market conditions.

5. The method according to claim 2, wherein compatible graphic components associated with the graphical user interface connect together graphically via predetermined rules.

6. The method according to claim 4, wherein the set of graphic components associated with the graphical user interface includes graphic components that implement logical or mathematical operations.

7. The method according to claim 4, wherein the set of graphic components associated with the graphical user interface includes graphic components that implement conditional operations.

8. The method according to claim 4, wherein the set of graphic components associated with the graphical user interface includes graphic components that implement comparison operators.

9. The method according to claim 1, wherein the algorithmic trading strategies include multi-legged option spreads.

10. The method according to claim 1, wherein the user is able to test the performance of a specific algorithmic trading strategy against historical market data.

11. The method according to claim 1, wherein the user is presented with real-time feedback on the performance of an algorithmic trading strategy while the strategy is being constructed via continuously updated risk graphs.

12. The method according to claim 1, wherein the results from the testing of an algorithmic trading strategy are presented to a user in the form of time-series data.

13. The method according to claim 12, wherein the results from the testing of an algorithmic trading strategy are presented to a user in the form of cross-sectional data.

14. The method according to claim 13, wherein the user can interact graphically with the time series data plot, with the corresponding cross-sectional data plot being updated according to the selection from the time series data plot.

15. The method according to claim 1, wherein the user is presented with an option to evaluate the performance of a trading strategy over a plurality of time periods selected by the user.

16. The method according to claim 1, further comprising translating the data associated with a trading strategy into a higher level computer programming language.

17. The method according to claim 13, wherein translating the data associated with a trading strategy into a higher level computer programming language is presented to the user.

18. A computer system comprising:
a web server configured to transfer data to and from a client device;
a market quote server configured to retrieve historical market data from external market servers;
an analytics server configured to test a user-generated algorithmic trading strategy based on historical market data;
a database configured to store user profiles and data; and
an application server configured to communicate data with the database.

19. The computer system according to claim 18, wherein the web server presents mobile code to the client device, wherein the mobile code allows the client device to display a graphical user interface to a user for the creation and editing of algorithmic trading strategies.

20. The computer system according to claim 18, wherein the application server evaluates the performance of user data submitted by the client device as compared to historical market data retrieved from the market quote server.

21. The computer system according to claim 18, wherein the user input via the graphical user interface is translated into a higher level programming language, which is then compiled and executed by the analytics server.
